(19) United States
(12) Patent Application Publication
(10) Pub. No.: US 2018/0006346 A1
(43) Pub. Date: Jan. 4, 2018

(54) PRESSURE MAINTENANCE RESERVOIR

(71) Applicant: Faraday&Future Inc., Gardena, CA (US)

(72) Inventors: William Smith, Long Beach, CA (US); Marco Eikenkamp, Marina del Rey, CA (US)

(21) Appl. No.: 15/198,266

(22) Filed: Jun. 30, 2016

(51) Int. Cl. H01M 10/625; H01M 10/613

(52) U.S. Cl. CPC H01M 10/625; H01M 10/613

(57) ABSTRACT

Methods, systems, and apparatuses to house cooling fluid for a battery are presented which include a main reservoir configured to house battery cooling fluid, the main reservoir including an overflow opening; and a flexible overflow reservoir coupled to the overflow opening and configured to (1) flexibly expand in volume during inflow of excess battery cooling fluid from the main reservoir through the overflow opening and (2) flexibly contract in volume during outflow of excess battery cooling fluid to the main reservoir through the overflow opening; the flexible overflow reservoir further configured to maintain a substantially same internal pressure during an expanded state or a contracted state of the flexible overflow reservoir.

### BACKGROUND

Aspects of the disclosure relate to a reservoir configured to house cooling fluid for a battery, such as for an electric vehicle's battery. During prolonged operation of a battery, such as in a moving electric vehicle, heat is generated by the battery which can become detrimental to the battery performance. Current liquid cooling mechanisms employed for cooling vehicle battery systems provide limited cooling capacity and efficiency. Exemplary embodiments of the disclosure address these problems, both individually and collectively.

### SUMMARY

Certain embodiments are described for pressure maintenance in a reservoir housing battery cooling fluid. An exemplary embodiment includes an apparatus having a main reservoir configured to house battery cooling fluid, the main reservoir including an overflow opening; and a flexible overflow reservoir coupled to the overflow opening and configured to (1) flexibly expand in volume during inflow of excess battery cooling fluid from the main reservoir through the overflow opening and (2) flexibly contract in volume during outflow of excess battery cooling fluid to the main reservoir through the overflow.

Another exemplary embodiment includes an apparatus having a first means for housing battery cooling fluid, the first means including an overflow opening; and a second means for housing overflow battery cooling fluid, the second means coupled to the overflow opening, the second means including (1) means for flexibly expanding in volume during inflow of excess battery cooling fluid from the first means through the overflow opening and (2) means for flexibly contracting in volume during outflow of excess battery cooling fluid to the first means through the overflow opening and (3) means for maintaining a substantially same internal pressure during an expanded state or a contracted state of the second means.

Another exemplary embodiment includes a method comprising housing battery cooling fluid in a main reservoir, the main reservoir including an overflow opening; housing overflow battery cooling fluid of the main reservoir in a flexible overflow reservoir coupled to the overflow opening and configured to (1) flexibly expand in volume during inflow of excess battery cooling fluid from the main reservoir through the overflow opening and (2) flexibly contract in volume during outflow of excess battery cooling fluid to the main reservoir through the overflow opening; and maintaining a substantially same internal pressure at the flexible overflow reservoir during an expanded state or a contracted state of the flexible overflow reservoir.

### BRIEF DESCRIPTION OF THE DRAWINGS

Aspects of the disclosure are illustrated by way of example. In the accompanying figures, like reference numbers indicate similar elements.

FIG. 1 illustrates an example environment in which various aspects of the disclosure can be implemented.

FIG. 2 and FIG. 3 include cross sectional diagrams further illustrating various components for implementing aspects of the disclosure.

FIG. 4 illustrates an exemplary operation flow of various aspects of the disclosure.

### DETAILED DESCRIPTION

Examples are described herein in the context of a flexible overflow reservoir for housing cooling fluid for a battery. Embodiments provided in the following description are illustrative only and not intended to limit the scope of the present disclosure. Reference will now be made in detail to implementations of examples as illustrated in the accompanying drawings. The same reference indicators will be used throughout the drawings and the following description to refer to the same or like items.

In the interest of clarity, not all of the routine features of the examples described herein are shown and described. It will, of course, be appreciated that in any such actual implementation, numerous implementation-specific details may nevertheless exist in order to achieve goals such as compliance with application- and business-related constraints, and that these specific goals can vary from one implementation to another.

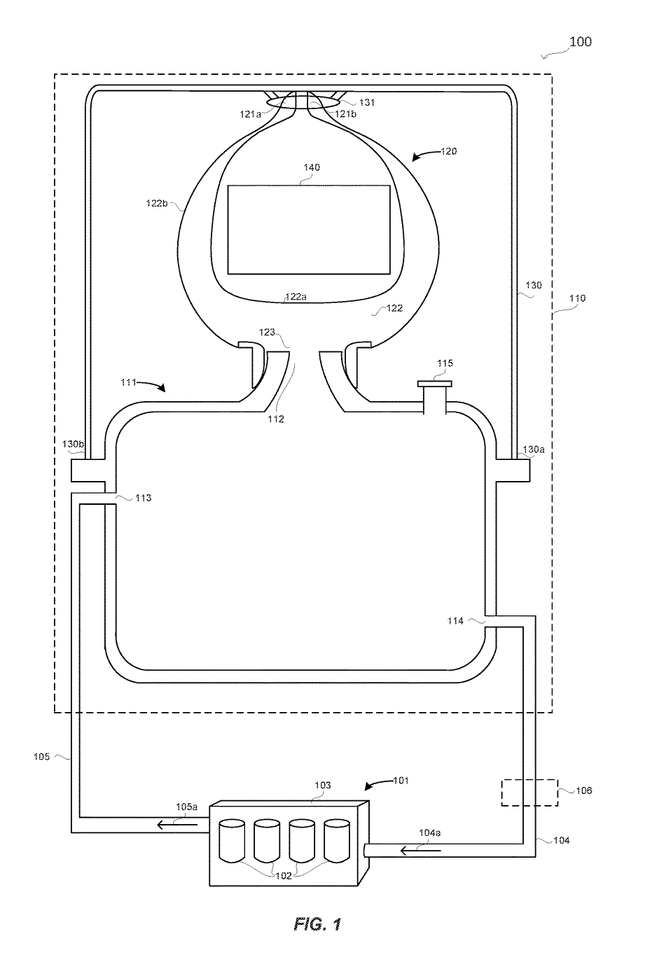

FIG. 1 illustrates an example environment 100 in which the various aspects of the disclosure can be implemented. FIG. 1 illustrates a battery unit 101, such as a vehicle battery, which includes battery cell(s) 102 housed inside a chamber 103. The battery cell(s) 102 are cooled via battery cooling fluid (not shown) in which the battery cell(s) 102 are partially or fully submersed. Alternatively, the battery cell(s) 102 are not in physical contact with the cooling fluid, but are nevertheless thermally coupled to the cooling fluid, such as via a cooling plate (not shown) that makes contact with the battery cell(s) 102. In the exemplary embodiment shown in FIG. 1, the battery cooling fluid flows into the battery unit 101 via the conduit 104, such as a pipe, in the direction of arrow 104a, and absorbs the heat from battery cell(s) 102. The heated battery cooling fluid then outputs from the battery unit 101 via the conduit 105, in the direction of arrow 105a, is received in a pressure management apparatus 110, and then returned to the battery unit 101 via the conduit 104.

As shown in FIG. 1, the pressure management apparatus 110 includes a main reservoir 111 configured to house battery cooling fluid received from the battery unit 101. In an exemplary embodiment, the main reservoir 111 is located at a higher elevation relative to the battery unit 101 in a vehicle (not shown). In an exemplary embodiment, the main reservoir 111 is of a rigid composition or construction.

The main reservoir 111 includes a fluid inlet 113 for receiving heated battery cooling fluid from the battery unit 101, such as via the conduit 105, into the main reservoir 111. The main reservoir 111 also includes a fluid outlet 114 for outputting battery cooling fluid from the main reservoir 111 to the battery unit 101, such as via the conduit 104. In an exemplary embodiment, the fluid inlet 113 is located at a higher elevation relative to the fluid outlet 114.

In an exemplary embodiment, a cooling apparatus 106 maybe positioned along conduit 104 (shown) or along conduit 105 (not shown), or both. The cooling apparatus 106 mixes or thermally couples the heated battery cooling fluid with other cooling agent(s), such as air flow or a fluid of lower temperature, to further reduce the temperature of the heated battery cooling fluid before re-entering the battery unit 101.

In an exemplary embodiment, a capped fill port 115 allows for replenishing or replacing of battery cooling fluid from an outside source when needed. As shown in FIG. 1, the main reservoir 111 includes an overflow opening 112 located at a higher elevation relative to the fluid inlet 113.

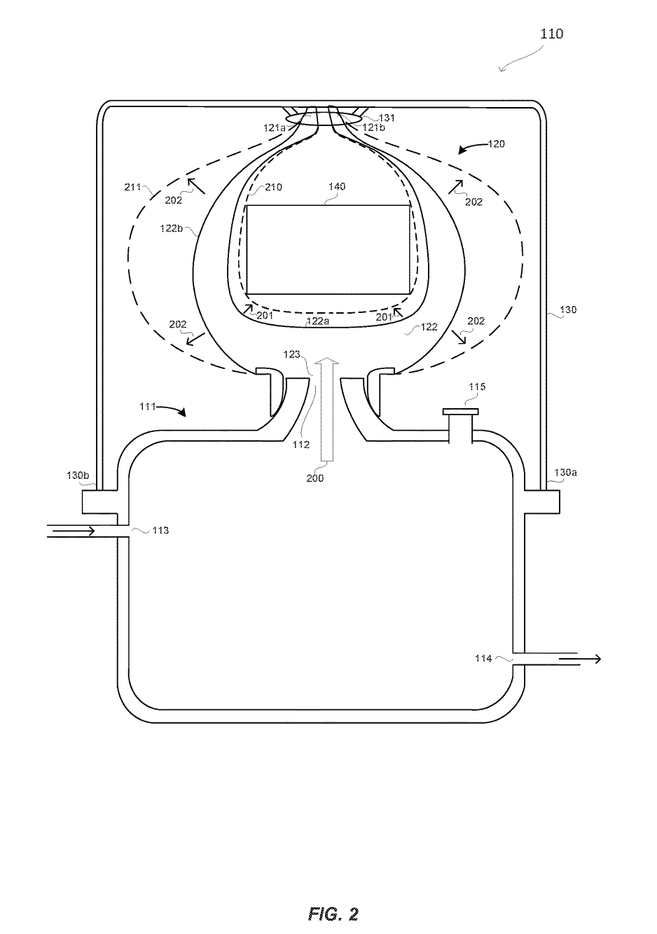

The pressure management apparatus 110 also includes a flexible overflow reservoir 120 coupled to the overflow opening 112, such as via the opening 123. The flexible overflow reservoir 120, shown in a contracted state in FIG. 1, also includes end portions 121a and 121b, and is located at a high elevation portion of the main reservoir 111 (e.g., at the top of reservoir 111 as shown in FIG. 1). In an exemplary embodiment a structural member 140 is optionally included in the pressure management apparatus 110. The operation of the pressure management apparatus 110, which includes the flexible overflow reservoir 120, is further described below and in greater detail in conjunction with FIGS. 2-4.

As also shown in FIG. 1, in an exemplary embodiment, a rigid cover 130 houses the flexible overflow reservoir 120. The rigid cover 130 is coupled, such as by fasteners, at its end portions 130a and 130b, to the main reservoir 111. In an exemplary embodiment, the rigid cover 130 is also coupled to the end portions 121a and 121b of the flexible overflow reservoir 120, such via removable fasteners 131.

The operation of the pressure management apparatus 110, which includes the flexible overflow reservoir 120, will now be described and in greater detail in conjunction with FIGS. 2-4. As shown in FIG. 2, entry of excess heated battery cooling fluid into the main reservoir 111 may result in excess heated battery cooling fluid, along with any gases, to flow in the direction of the arrow 200 through the overflow opening 112 and the opening 123, into the flexible overflow reservoir 120.

The flexible overflow reservoir 120 is configured to flexibly expand in volume during inflow of excess battery cooling fluid from the main reservoir 111. By allowing the volume to expand, the flexible overflow reservoir 120 maintains the internal pressure of the system at a substantially constant level even as the temperature of the battery cooling fluid changes. The internal pressure within the main reservoir 111 and the flexible overflow reservoir 120 may thus be maintained at a relatively constant level, e.g., at just above 1 atmosphere but not exceeding a higher level such as 3 atmospheres. In an exemplary embodiment, the flexible overflow reservoir 120 includes an elongated body 122 for housing excess battery fluid, the elongated body 121 having main inner surface 122a and outer surface 122b.

As shown in the cross-sectional view of FIG. 2, entry of excess heated battery cooling fluid from the main reservoir 111 into the flexible overflow reservoir 120 causes the flexible overflow reservoir 120 to flexibly expand along the inner surface 122a, such as in the direction of arrows 201, and along the outer surface 122b, such as in the direction of arrows 202, to an expanded state as delineated by the dotted lines 210 and 211, respectively. The flexible overflow reservoir 120 is configured to expand within the area encased by the rigid cover 130.

The flexible overflow reservoir 120 is further configured to maintain a substantially same internal pressure during the expanded state of the flexible overflow reservoir 120. In an exemplary embodiment, the flexible overflow reservoir 120 is coupled to the main reservoir 111 in a sealed configuration to maintain a substantially same internal pressure during an expanded state of the flexible overflow reservoir 120.

In an exemplary embodiment a structural member 140 is optionally included in the pressure management apparatus 110. As shown in FIG. 2, the structural member 140 is configured to be placed adjacent to the flexible overflow reservoir 120, such as adjacent to the inner surface 122a, to guide a shape of the flexible overflow reservoir 120 as it flexibly expands. The structure member 140 may thus prevent undesired kinks, folds, wells, or other unintended shapes to form in the flexible overflow reservoir 120. Such undesirable shapes in the flexible overflow reservoir 120 may trap pockets of fluid and/or prevent proper drainage of the flexible overflow reservoir 120. For example, the structural member 140 may be of a rigid composition or construction to limit the inward expansion of the overflow reservoir 120 by the inner surface 122a. For simplicity of illustration, the structural member 140 is shown as having a rectangular cross-section, although other shapes and configuration can also be used and are contemplated to be within the scope of the present disclosure.

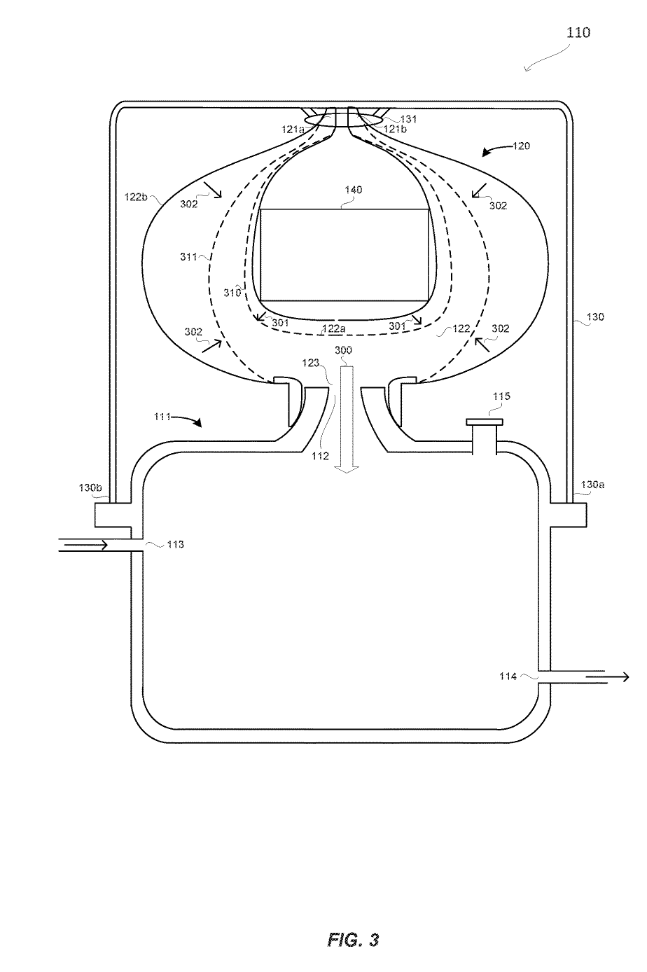

FIG. 3 illustrates the flexible overflow reservoir 120 in an expanded state. A reduction in the volume of battery cooling fluid in the entire system (including battery unit 101, conduits 104 and 105, pressure management apparatus 110), may occur when the temperature of the battery cooling fluid decreases This reduction in the volume of the battery cooling fluid may cause excess battery cooling fluid to flow from the flexible overflow reservoir 120 in the direction of the arrow 300 through opening 123 and the overflow opening 112, into the main reservoir 111.

As shown in the cross-sectional view of FIG. 3, outflow of battery cooling fluid from the flexible overflow reservoir 120 into the main reservoir 111 causes the flexible overflow reservoir 120 to flexibly contract along the inner surface 122a, such as in the direction of arrows 301, and along the outer surface 122b, such as in the direction of arrows 302, to a contracted state as delineated by the dotted lines 310 and 311, respectively.

The flexible overflow reservoir 120 is further configured to maintain a substantially same internal pressure during the contracted state of the flexible overflow reservoir 120. In an exemplary embodiment, the flexible overflow reservoir 120 is coupled to the main reservoir 111 in a sealed configuration to maintain a substantially same internal pressure during a contracted state of the flexible overflow reservoir 120.

In an exemplary embodiment, the structural member 140 is configured to facilitate the outflow of the battery cooling fluid from the flexible overflow reservoir 120 to the main reservoir 111 through opening 123 and the overflow opening 112. For example, the structural member 140 may be of a rigid composition or construction whose weight contributes to the outflow of battery cooling fluid from the flexible overflow reservoir 120 to the main reservoir 111.

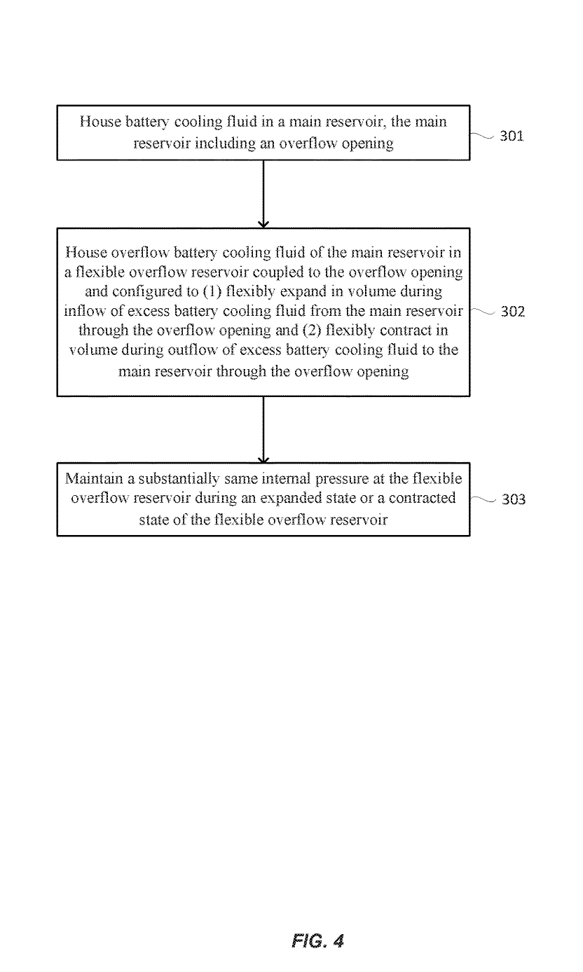

FIG. 4, in conjunction with FIGS. 1-3, illustrates an exemplary operation flow of various aspects of the disclosure. Starting in block 301, battery cooling fluid is housed in the main reservoir 111 which includes the overflow opening 112.

Next, in block 302, overflow battery cooling fluid of the main reservoir 111 is housed in the flexible overflow reservoir 120 coupled to the overflow opening 112. The flexible overflow reservoir 120 is configured to (1) flexibly expand in volume during inflow of excess battery cooling fluid from the main reservoir 111 through the overflow opening 112 and (2) flexibly contract in volume during outflow of excess battery cooling fluid to the main reservoir 111 through the overflow opening 112.

Next, in block 303, substantially the same internal pressure at the flexible overflow reservoir 120 is maintained during an expanded state or a contracted state of the flexible overflow reservoir 120.

It is understood that the specific order or hierarchy of steps in the processes disclosed is an illustration of exemplary approaches. Based upon design preferences, it is understood that the specific order or hierarchy of steps in the processes may be rearranged. Further, some steps may be combined or omitted. The accompanying method claims recite various steps in a sample order. Unless otherwise specified, the order in which the steps are recited is not meant to require a particular order in which the steps must be executed.

The previous description is provided to enable any person skilled in the art to practice the various aspects described herein. Various modifications to these aspects will be readily apparent to those skilled in the art, and the generic principles defined herein may be applied to other aspects.

Operations described in the present disclosure may be controlled and/or facilitated by software, hardware, or a combination of software and hardware. Operations described in the present disclosure may be controlled and/or facilitated by software executing on various machines. Such operations may also be controlled and/or facilitated specifically-configured hardware, such as field-programmable gate array (FPGA) specifically configured to execute the various steps of particular method(s). For example, relevant operations can be implemented in digital electronic circuitry, or in computer hardware, firmware, software, or in a combination thereof. In one example, a device may include a processor or processors. The processor may be coupled to a computer-readable medium, such as a random access memory (RAM). The processor may execute computer-executable program instructions stored in memory, such as executing one or more computer programs. Such processors may comprise a microprocessor, a digital signal processor (DSP), an application-specific integrated circuit (ASIC), field programmable gate arrays (FPGAs), and/or state machines. Such processors may further comprise programmable electronic devices such as PLCs, programmable interrupt controllers (PICs), programmable logic devices (PLDs), programmable read-only memories (PROMs), electronically programmable read-only memories (EPROMs or EEPROMs), or other similar devices.

Such processors may comprise, or may be in communication with, media, for example computer-readable storage media, that may store instructions that, when executed by the processor, can cause the processor to perform the steps described herein as carried out, or assisted, by a processor. Examples of computer-readable media may include, but are not limited to, an electronic, optical, magnetic, or other storage device capable of providing a processor, such as the processor in a web server, with computer-readable instructions. Other examples of media comprise, but are not limited to, a floppy disk, CD-ROM, magnetic disk, memory chip, ROM, RAM, ASIC, configured processor, optical media, magnetic tape or other magnetic media, and/or any other medium from which a computer processor can read. The processor, and the processing, described may be in one or more structures, and may be dispersed through one or more structures. The processor may comprise code for carrying out one or more of the methods (or parts of methods) described herein.

The foregoing description has been presented only for the purpose of illustration and description and is not intended to be exhaustive or to limit the disclosure to the precise forms disclosed. Numerous modifications and adaptations thereof will be apparent to those skilled in the art without departing from the spirit and scope of the disclosure.

Reference herein to an example or implementation means that a particular feature, structure, operation, or other characteristic described in connection with the example may be included in at least one implementation of the disclosure. The disclosure is not restricted to the particular examples or implementations described as such. The appearance of the phrases “in one example,” “in an example,” “in one implementation,” or “in an implementation,” or variations of the same in various places in the specification does not necessarily refer to the same example or implementation. Any particular feature, structure, operation, or other characteristic described in this specification in relation to one example or implementation may be combined with other features, structures, operations, or other characteristics described in respect of any other example or implementation.

Use herein of the word “or” is intended to cover inclusive and exclusive OR conditions. In other words, A or B or C includes any or all of the following alternative combinations as appropriate for a particular usage: A alone; B alone; C alone; A and B only; A and C only; B and C only; and A and B and C.

What is claimed is:

1. An apparatus, comprising:
a main reservoir configured to house battery cooling fluid, the main reservoir including an overflow opening; and
a flexible overflow reservoir coupled to the overflow opening and configured to (1) flexibly expand in volume during inflow of excess battery cooling fluid from the main reservoir through the overflow opening and (2) flexibly contract in volume during outflow of excess battery cooling fluid to the main reservoir through the overflow opening; the flexible overflow reservoir further configured to maintain a substantially same internal pressure during an expanded state or a contracted state of the flexible overflow reservoir.

2. The apparatus of claim 1, wherein the flexible overflow reservoir is located at a high elevation portion of the main reservoir.

3. The apparatus of claim 1, the main reservoir further comprising:
a fluid inlet for receiving battery cooling fluid into the main reservoir; and
a fluid outlet for outputting battery cooling fluid from the main reservoir,
wherein the fluid inlet is located at a higher elevation relative to the fluid outlet.

4. The apparatus of claim 3, wherein the overflow opening is located at a higher elevation relative to the fluid inlet.

5. The apparatus of claim 1, wherein the flexible overflow reservoir further comprising:
an elongated body for housing excess battery fluid, the elongated body having a first end portion and a second end portion; and
an opening coupled to the overflow opening of the main reservoir, to enable inflow of excess battery cooling fluid from the main reservoir and outflow of excess battery cooling fluid to the main reservoir.

6. The apparatus of claim 1, further comprising:
a rigid cover coupled to the main reservoir, the rigid cover housing the flexible overflow reservoir.

7. The apparatus of claim 6, wherein the flexible overflow reservoir is coupled to the rigid cover.

8. The apparatus of claim 1, further comprising one or more battery modules cooled by the battery cooling fluid, and wherein the main reservoir is located at a higher elevation relative to the one or more battery modules in a vehicle.

9. The apparatus of claim 1, the main reservoir further comprising a fill port.

10. The apparatus of claim 1, further comprising:
a structural member configured to be placed adjacent to the flexible overflow reservoir and to guide a shape of the flexible overflow reservoir as it flexibly expands or contracts, the structural member further configured to facilitate the outflow of the excess battery cooling fluid from the flexible overflow reservoir to the main reservoir through the overflow opening.

11. The apparatus of claim 1, wherein the main reservoir is rigid.

12. The apparatus of claim 1, wherein the flexible overflow reservoir is coupled to the main reservoir in a sealed configuration.

13. An apparatus, comprising:
a first means for housing battery cooling fluid, the first means including an overflow opening; and
a second means for housing overflow battery cooling fluid, the second means coupled to the overflow opening, the second means including (1) means for flexibly expanding in volume during inflow of excess battery cooling fluid from the first means through the overflow opening and (2) means for flexibly contracting in volume during outflow of excess battery cooling fluid to the first means through the overflow opening and (3) means for maintaining a substantially same internal pressure during an expanded state or a contracted state of the second means.

14. The apparatus of claim 13, the first means further comprising:
means for receiving battery cooling fluid; and
means for outputting battery cooling fluid.

15. The apparatus of claim 13, wherein the second means further comprising:
means for enabling inflow of excess battery cooling fluid from, and outflow of excess battery cooling fluid to, the first means.

16. The apparatus of claim 13, further comprising:
means for housing the second means; and
means for coupling the means for housing to the first means.

17. The apparatus of claim 16, further comprising:
means for coupling the second means to the means for housing the second means.

18. The apparatus of claim 13, further comprising:
means for guiding a shape of the second means as it flexibly expands or contracts, and means for facilitating the outflow of the excess battery cooling fluid from the second means to the first means through the overflow opening.

19. The apparatus of claim 1, wherein the second means is located at a higher elevation relative to the first means.

20. A method comprising:
housing battery cooling fluid in a main reservoir, the main reservoir including an overflow opening;
housing overflow battery cooling fluid of the main reservoir in a flexible overflow reservoir coupled to the overflow opening and configured to (1) flexibly expand in volume during inflow of excess battery cooling fluid from the main reservoir through the overflow opening and (2) flexibly contract in volume during outflow of excess battery cooling fluid to the main reservoir through the overflow opening; and
maintaining a substantially same internal pressure at the flexible overflow reservoir during an expanded state or a contracted state of the flexible overflow reservoir.
